(19) United States
(12) Patent Application Publication
(10) Pub. No.: US 2018/0105609 A1
(43) Pub. Date: Apr. 19, 2018

(54) PREPARATION OF WATER SOLUBLE TRIVALENT IRON CARBOHYDRATE COMPLEXES

(71) Applicant: Suven Life Sciences Limited, Hyderabad (IN)

(72) Inventors: Udaya Bhaskara Rao Siripalli, Hyderabad (IN); Lakshmi Narasimhulu Gorentla, Hyderabad (IN); Veera Reddy Arava, Hyderabad (IN); Mohana Rao Manam, Hyderabad (IN); Venkateswarlu Jasti, Hyderabad (IN)

(21) Appl. No.: 15/559,976

(22) PCT Filed: May 6, 2015
(86) PCT No.: PCT/IB2015/053305

§ 371 Date: Sep. 20, 2017

(30) Foreign Application Priority Data
Mar. 23, 2015 (IN) 1473/CHE/2015

(51) Int. Cl. C08B 31/18; C08L 3/10; C08B 30/18

(52) U.S. Cl. CPC C08B 31/18; C08B 30/18; C08L 3/10

(57) ABSTRACT

The present invention provides an improved process for the preparation of Ferric carboxymaltose (FCM) complex. In this process the oxidation of maltodextrins are carried out by using an organic hypo halite in the presence of a catalyst and a phase transfer catalyst and later complex formation with ferric salt or ferric hydroxide or iron hydroxide maltodextrin complex.

### FIELD OF THE INVENTION

The present invention provides an improved process for the preparation of water soluble trivalent iron carbohydrate complexes obtainable from oxidation of maltodextrins using organic hypohalite. In particular, the present invention provides an improved process for the preparation of Ferric carboxymaltose.

### BACKGROUND OF THE INVENTION

Iron deficiency anaemia (IDA) is a common haematological complication with potentially serious clinical consequences that may require intravenous iron therapy.

Ferric carboxymaltose (FCM) is a stable, non-dextran iron formulation administered intravenously in large single doses to treat IDA. It is an iron complex that consists of a ferric hydroxide core stabilized by a carbohydrate shell. It is commercially available in the market under the trade name Ferinject®.

Ferric carboxymaltose has been designed to provide high iron utilisation and to have a better benefit to risk profile than iron dextran and iron sucrose therapy. In the case of iron dextran, a key risk is the reaction with anti-dextran antibodies leading to the well known dextran induced anaphylactic reactions. In the case of iron sucrose, the negative characteristics include high pH, high osmolarity, low dosage limits and the long duration of administration.

Ferric carboxymaltose allows for controlled delivery of iron within the cells of the reticuloendothelial system and subsequent delivery to the iron-binding proteins ferritin and transferrin, with minimal risk of release of large amounts of ionic iron in the serum.

U.S. Pat. No. 3,076,798 discloses a process for the preparation of iron (III)-polymaltose complex compounds. The iron (III)-polymaltose complex compound preferably has a molecular weight in the range from 20,000 to 500,000 daltons, preferably from 30,000 to 80,000 daltons.

U.S. Pat. No. 7,612,109 discloses water-soluble iron carbohydrate complexes (ferric carboxymaltose complexes) obtainable from an aqueous solution of an iron (III) salt, preferably iron (III) chloride, and an aqueous solution of the oxidation product of one or more maltodextrins using an aqueous hypochlorite solution.

PCT application No. WO2011/055374, discloses a process for the preparation of iron (III) carboxymaltose complex using ferric hydroxide.

Even though many prior art processes reported methods for the preparation of Iron (III) carboxymaltose, each process has some limitations with respect to yield, purity and scale-up etc.

### OBJECTIVES OF THE INVENTION

An object of the present invention is to provide an improved process for the preparation of iron carbohydrate complex having weight average molecular weight of 80 kDa to 400 kDa obtainable from oxidation of maltodextrins using organic hypo halite in the presence of a catalyst and phase transfer catalyst or mixtures thereof and ferric salt or ferric hydroxide.

Another object of the present invention is to provide an improved process for the preparation of Ferric carboxymaltose (FCM) obtainable from oxidation of maltodextrins with organic hypohalite in the presence of transition metal catalyst and phase transfer catalyst and ferric salt or ferric hydroxide.

Yet, another object of the present invention is to provide an improved process for the preparation of Ferric carboxymaltose (FCM) obtainable from oxidation of maltodextrins with organic hypohalite in the presence of alkali halide as a catalyst, phase transfer catalyst and ferric salt or ferric hydroxide.

In yet another object of the present invention is to provide a process for the preparation of Ferric carboxymaltose (FCM) wherein the oxidation is carried out in the presence of organic hypohalite solution, which is easily separable from an aqueous solution and safe to handle.

### SUMMARY OF THE INVENTION

Accordingly, the present invention provides a process for the preparation of water soluble iron (III) carboxymaltose complex having average molecular weight of 80 kDa to 400 kDa comprising the reaction product of
a) an aqueous solution of Iron (III) complex and
b) an aqueous solution of oxidation product of
   i) at least one maltodextrin and
   ii) an organic hypohalite as oxidising agent
   iii) in the presence of a catalyst and phase transfer catalyst
   iv) in alkaline medium
wherein, the reaction mixture is stirred for about 15 minutes after the addition of organic hypohalite in alkaline medium,
wherein, the reaction mixture is cooled to 25-30° C. after the addition of Iron (III) complex,
wherein, the reaction mixture in step b) is isolated at a pH of 2 or less at a temperature of 25-30° C. and filtered the reaction mixture,
wherein, the reaction mixture is stirred for about 2 hours at room temperature after the addition of alcoholic solvent.

In another aspect, the present invention provides an improved process for the preparation of Ferric carboxymaltose (FCM) which comprises:
a) oxidizing at least one maltodextrin at a pH in the range of 9 to 12 and at a temperature in the range of 0 to 40° C., with organic hypohalite in the presence of a catalyst and a phase-transfer catalyst to form an oxidized maltodextrin solution,
b) contacting the oxidized maltodextrin solution with an aqueous solution of an iron (III) complex,
c) raising the pH of the oxidized maltodextrin solution and iron (III) complex to a value in the range of 9 to 12,
d) lowering the pH of the oxidized maltodextrin solution and iron (III) complex to a value in the range of 4 to 6 and
e) isolating Ferric carboxymaltose (FCM) by adding alcohol to the aqueous complex solution.
wherein, the reaction mixture is stirred for about 15 minutes after the addition of organic hypohalite in alkaline medium, wherein, the reaction mixture is cooled to 25-30° C. after the addition of Iron (III) complex,
wherein, the reaction mixture in step d) is isolated at a pH of 2 or less at a temperature of 25-30° C. and filtered the reaction mixture, wherein, the reaction mixture is stirred for about 2 hours at room temperature after the addition of alcoholic solvent in step e.

### DETAILED DESCRIPTION OF THE INVENTION

One aspect of the present invention provides an improved process for the preparation of water soluble trivalent iron carbohydrate complex having a weight average molecular weight of 80 kDa to 400 kDa obtainable from oxidation of maltodextrins using an organic hypohalite as oxidising agent in the presence of a catalyst, a phase-transfer catalyst, at an alkaline pH, and complex formation with ferric salt or ferric hydroxide or ferric hydroxide maltodextrin complex wherein, when one maltodextrin is present, the maltodextrin has a dextrose equivalent of between 5 and 20, and wherein, when a mixture of more than one maltodextrin is present, the dextrose equivalent of each individual maltodextrin is between 2 and 40, and the dextrose equivalent of the mixture is between 5 and 20.

The oxidation reaction is carried out in the presence of a catalyst such as transition metal catalyst or alkali halide.

Another aspect of the present invention is to provide an improved process for the preparation of Ferric carboxymaltose (FCM) which comprises reacting an aqueous solution of Iron (III) complex and aqueous solution of oxidised maltodextrin wherein the oxidation is carried out using an organic hypohalite solution as oxidising agent and a phase-transfer catalyst at an alkaline pH in the presence of transition metal catalyst.

Yet another aspect of the present invention, is to provide an improved process for the preparation of water soluble iron (III) carbohydrate complex having a weight average molecular weight of 80 kDa to 400 kDa obtainable from oxidation of maltodextrins using an organic hypohalite as oxidising agent in the presence of alkali halide as a catalyst, phase-transfer catalyst at an alkaline pH, and complex formation with ferric salt or ferric hydroxide or ferric hydroxide maltodextrin complex wherein, when one maltodextrin is present, the maltodextrin has a dextrose equivalent of between 5 and 20, and wherein, when a mixture of more than one maltodextrin is present, the dextrose equivalent of each individual maltodextrin is between 2 and 40, and the dextrose equivalent of the mixture is between 5 and 20.

Another aspect of the present invention is to provide an improved process for the preparation of Ferric carboxymaltose (FCM) which comprises reacting an aqueous solution of Iron (III) complex and aqueous solution of oxidised maltodextrin wherein the oxidation is carried out using an organic hypohalite solution as oxidising agent and a phase-transfer catalyst at an alkaline pH in the presence of alkali halide as a catalyst.

The organic hypohalites [Chem. Rev. 1954, 54(6), 925-958] used for oxidising maltodextrin is selected from an alkyl or aryl or arylalkyl hypohalite, specifically C₁-C₄ alkyl hypohalites, more specifically, t-butyl hypochlorite.

The oxidation reaction is carried out in the presence of a catalyst such as transition metal catalyst for example sodium tungstate. Sodium tungstate used in the present invention can be anhydrous, monohydrate, dihydrate or any other variation thereof.

The oxidation reaction is carried out in the presence of a catalyst such as alkali halide catalyst, specifically alkali bromides, for example sodium bromide.

Specifically, the amount of catalyst is kept as low as possible in order to achieve the end product which can easily be purified, and more specifically catalytic amounts are sufficient.

The phase-transfer catalyst used herein is selected from C₁-C₁₀ alkyl or aryl or arylalkyl ammonium halides, specifically Aliquat 336 (methyl trioctylammonium chloride), or mixtures thereof.

Aqueous solution of Iron (III) complex of the present invention used as starting material is ferric salt for example ferric chloride or ferric hydroxide or polymeric ferric hydroxide maltodextrin complex.

In a preferred embodiment, the present invention provides a process for the preparation of water soluble iron (III) carboxymaltose complex having average molecular weight of 80 kDa to 400 kDa comprising the reaction product of
a) an aqueous solution of Iron (III) complex and
b) an aqueous solution of oxidation product of
   i) at least one maltodextrin and
   ii) an organic hypohalite as oxidising agent
   iii) in the presence of a catalyst and phase transfer catalyst
   iv) in alkaline medium
wherein, the reaction mixture is stirred for about 15 minutes after the addition of organic hypohalite in alkaline medium,
wherein, the reaction mixture is cooled to 25-30° C. after the addition of Iron (III) salt,
wherein, the reaction mixture in step b) is isolated at a pH of 2 or less at a temperature of 25-30° C. and filtered the reaction mixture,
wherein, the reaction mixture is stirred for about 2 hours at room temperature after the addition of alcoholic solvent.

To prepare the complex of the invention, the obtained oxidized maltodextrins are reacted with Iron (III) complex. In order to do so, the oxidized maltodextrins can be isolated and re-dissolved. It is also possible to use the obtained aqueous solutions of the oxidized maltodextrins directly for further reaction with Iron (III) complex. For instance, the aqueous solution of the oxidized maltodextrin can be mixed with ferric chloride in order to carry out the reaction.

The oxidation may be carried out in an alkali solution, for example at a pH of 9 to 12. The oxidation may be carried out at temperatures in the range of 0 to 40° C., preferably of 15 to 30° C. The reaction may be carried out for a period of 10 minutes to 3 hours, preferably 15 min.

The aqueous solution of the oxidized maltodextrin can be mixed with an aqueous solution of the iron (III) complex in order to carry out the reaction. It is preferred to proceed in a manner so that during and immediately after mixing of the oxidized maltodextrin and the iron (III) complex, the pH is acidic and adjusted to an alkaline pH to a value in the range of 9 to 12, preferably 10 to 11, and maintaining the reaction at a temperature of 25 to 60° C., preferably 50 to 55° C.

During the oxidation, pH is initially maintained at 1 to 3 and at a temperature of 0 to 50° C., followed by adjusting the pH between 9 to 12 with an aqueous alkali hydroxide, preferably sodium hydroxide and maintaining the reaction at a temperature of 25 to 45° C., preferably 25 to 30° C. Later, the pH can be adjusted to 5 to 6, preferably 5.5, by the addition of aqueous hydrochloric acid and maintaining the reaction at a temperature of 25-30° C.

According to another preferable embodiment, the present invention provides an improved process for the preparation of Ferric carboxymaltose (FCM) which comprises:
a) oxidizing at least one maltodextrin at a pH in the range of 9 to 12 and at a temperature in the range of 0 to 40° C., with t-butyl hypochlorite to form an oxidized maltodextrin solution,
b) contacting the oxidized maltodextrin solution with an aqueous solution of an iron (III) salt,
c) raising the pH of the oxidized maltodextrin solution and iron (III) salt solution to a value in the range of 9 to 12,
d) lowering the pH of the oxidized maltodextrin solution and iron (III) salt solution to a value in the range of 4 to 6 and
e) isolating Ferric carboxymaltose (FCM) by adding alcohol to the aqueous complex solution.
wherein, the reaction mixture is stirred for about 15 minutes after the addition of organic hypohalite in alkaline medium,
wherein, the reaction mixture is cooled to 25-30° C. after the addition of Iron (III) salt,
wherein, the reaction mixture in step d) is isolated at a pH of 2 or less at a temperature of 25-30° C. and filtered the reaction mixture,
wherein, the reaction mixture is stirred for about 2 hours at room temperature after the addition of alcoholic solvent in step e.

In a most preferred embodiment, the present invention provides an improved process for the preparation of Ferric carboxymaltose (FCM) which comprises:
a) oxidizing at least one maltodextrin in an aqueous solution at a pH in the range of 9 to 12 and a temperature in the range of 0 to 50° C., with tert-butyl hypochlorite in the presence of a catalyst and a phase transfer catalyst to form an oxidized maltodextrin solution,
b) contacting the oxidized maltodextrin solution with an aqueous solution of an iron (III) salt,
c) raising the pH of the oxidized maltodextrin solution and iron (III) salt solution to a value in the range of 9 to 12,
d) raising the temperature of the reaction mixture to a temperature of 50-60°,
e) lowering the temperature of the reaction mixture to a temperature of 25-30° C.,
f) lowering the pH of the oxidized maltodextrin solution and iron (III) salt mixture to a value in the range of 4 to 6,
g) adding alcohol to the aqueous complex and stirring for about 2 hours and
h) isolating Ferric carboxymaltose (FCM) from the solution.

In another most preferred embodiment, the present invention provides an improved process for the preparation of Ferric carboxymaltose (FCM) which comprises:
a) oxidizing at least one maltodextrin in an aqueous solution at a pH in the range of 9 to 12 and a temperature in the range of 0 to 50° C., with tert-butyl hypochlorite in the presence of sodium tungstate and Aliquat 336 to form an oxidized maltodextrin solution,
b) contacting the oxidized maltodextrin solution with an aqueous solution of an iron (III) salt,
c) raising the pH of the oxidized maltodextrin solution and iron (III) salt solution to a value in the range of 9 to 12,
d) raising the temperature of the reaction mixture to a temperature of 50-60°,
e) lowering the temperature of the reaction mixture to a temperature of 25-30° C.,
f) lowering the pH of the oxidized maltodextrin solution and iron (III) salt mixture to a value in the range of 4 to 6,
g) adding alcohol to the aqueous complex and stirring for about 2 hours and
h) isolating Ferric carboxymaltose (FCM) from the solution.

In yet another most preferred embodiment, the present invention provides an improved process for the preparation of Ferric carboxymaltose (FCM) which comprises:
a) oxidizing at least one maltodextrin in an aqueous solution at a pH in the range of 9 to 12 and a temperature in the range of 0 to 50° C., with tert-butyl hypochlorite in the presence of sodium tungstate and Aliquat 336 to form an oxidized maltodextrin solution,
b) contacting the oxidized maltodextrin solution with a ferric chloride solution,
c) raising the pH of the oxidized maltodextrin solution and ferric chloride solution to a value in the range of 9 to 12,
d) raising the temperature of the reaction mixture to a temperature of 50-60°,
e) lowering the temperature of the reaction mixture to a temperature of 25-30° C.,
f) lowering the pH of the oxidized maltodextrin solution and ferric chloride mixture to a value in the range of 4 to 6,
g) adding ethanol to the aqueous complex and stirring for about 2 hours and
h) isolating Ferric carboxymaltose (FCM) from the solution.

The following examples describes the nature of the invention and are given only for the purpose of illustrating the present invention in more detail and are not limitative and relate to solutions which have been particularly effective on a bench scale.

### Preparation of Trivalent Iron Carboxymaltose:

### EXAMPLE-1

25 grams of maltodextrin (13-17 dextrose equivalents) was dissolved in 75 ml of purified water and the mixture was stirred for 10 minutes at room temperature. To this mixture 3.4 gm of Aliquat 336 and 0.05 gm of Na₂WO₄.2H₂O were added at room temperature. 30% NaOH solution was added to adjust the pH to 10 to 10.5 and 7 gm of tert-butyl hypochlorite (55 to 60 wt. % active chlorine) was added drop wise at 25-30° C. while maintaining the at pH 9.5 to 10.5 by adding 30% NaOH solution simultaneously. The reaction mixture was stirred for 1 hour at 25-30° C. and at pH 10 and then 40% NaOH solution (4.4 ml) was added drop wise to the reaction mass at 25-30° C.

To the above reaction mass, iron (III) chloride solution (30.66 gm of FeCl₃ dissolved in 57.5 ml of purified water) was added drop wise over a period of 20 minutes at 25-30° C. and stirred for 15 minutes. Aqueous sodium carbonate solution (24 gm of Na₂CO₃ dissolved in 115 ml of purified water) was added drop wise at 25-30° C. and then 40% NaOH solution was added to establish a pH of 10.5 to 11 and the mixture was heated to 50° C., stirred for 30 minutes. Then the mixture was acidified to pH 5.5 with hydrochloric acid addition and the solution was kept at 50° C. for another 30 minutes. Further temperature was raised to 95-100° C. and stirred for half an hour at pH 5.5. The reaction mixture was allowed to cool to room temperature and filtered through a celite pad. Then the iron (III) complex was isolated by precipitating with ethanol addition drop wise at room temperature. The obtained brown solid was dried under vacuum at 50° C. for 2-3 hours.

Molecular weight=202 kDa

Iron content=25.65% w/w

### EXAMPLE-2

### Step (i)

28 grams of anhydrous iron (III) chloride was dissolved in 50 ml of purified water at room temperature for 10 min stirring. The obtained brownish-yellow clear solution was cooled to 0-5° C. and the pH was adjusted to 7.0 by adding aqueous sodium hydroxide solution (21 gm of NaOH dissolved in 105 ml of purified water). A brown colour precipitate obtained was maintained for 1 hour at 0-5° C. and collected through filtration. The cake was suck dried and used for next step.

### Step (ii)

25 grams of maltodextrin (13-17 dextrose equivalents) was dissolved in 60 ml of purified water and the mixture was stirred for 10 min at room temperature. To this 20% NaOH solution was added to adjust the pH to 10 and followed by 0.1 gm of Na₂WO₄.2H₂O at room temperature over a period of 15 minutes. 3.3 gm of tert-butyl hypochlorite was added drop wise at 25-30° C. and maintained reaction mixture at pH 10 by adding 20% NaOH solution simultaneously. The reaction mixture was stirred for 1 hour at 25-30° C. and at pH 10.

At 25-30° C., wet cake of step (i) was added and stirred for 10 minutes. 20% NaOH solution was added drop wise to adjust the reaction mass pH to 10-11 and the slurry was heated to 50° C., stirred for 30 minutes (added 20% NaOH solution to maintain the alkaline pH). Then the solution was acidified to pH 5.5 with hydrochloric acid addition and the solution was kept at 50° C. for another 30 minutes. Further temperature was raised to 95-100° C. and stirred for half an hour at pH 5.5. The reaction mixture was allowed to cool to room temperature, adjusted pH to 6.0 with 20% NaOH solution and filtered through a celite pad. Then the iron (III) complex was isolated by precipitating with ethanol addition drop wise at room temperature. The obtained brown solid was dried under vacuum at 50° C. for 2-3 hours.

Molecular weight=284 kDa

Iron content=21.65% w/w

### EXAMPLE-3

### Step (i)

28 grams of anhydrous iron (III) chloride was dissolved in 50 ml of purified water at room temperature for 10 minutes stirring. To this 2 gm of maltodextrin (13-17 dextrose equivalents) was added and stirred for 10 minutes at room temperature. The obtained brownish-yellow clear solution was cooled to 0-5° C. and the pH of the reaction mixture was adjusted to 7.0 by adding 20% aqueous sodium hydroxide solution. A brown colour precipitate obtained was maintained for 1 hour at 0-5° C. and collected through filtration. The cake was suck dried and used for next step.

### Step (ii)

25 grams of maltodextrin (13-17 dextrose equivalents) was dissolved in 60 ml of purified water and the mixture was stirred for 10 minutes at room temperature. To this 20% NaOH solution was added to adjust the pH to 10 and followed by 0.1 gm of Na₂WO₄.2H₂O at room temperature. 6 gm of tert-butyl hypochlorite was added drop wise at 25-30° C. and maintained reaction mixture at pH 10 by adding 20% NaOH solution simultaneously. The reaction mixture was stirred for 1 hour at 25-30° C. and at pH 10.

At 25-30° C., wet cake of step (i) was added and stirred for 10 minutes. 20% NaOH solution was added drop wise to adjust the reaction mass pH to10 to 11 and the slurry was heated to 50° C., stirred for 30 minutes (added 20% NaOH solution to maintain the alkaline pH). Then the solution was acidified to pH 5.5 with hydrochloric acid addition and the solution was kept at 50° C. for another 30 minutes. Further temperature was raised to 95-100° C. and stirred for half an hour at pH 5.5. The reaction mixture was allowed to cool to room temperature, adjusted pH to 6.0 with 20% NaOH solution and filtered through a celite pad. Then the iron (III) complex was isolated by precipitating with ethanol addition drop wise at room temperature. The obtained brown amorphous solid was dried under vacuum at 50° C. for 2-3 hours.

Molecular weight=156 kDa

Iron content=21.13% w/w

### EXAMPLE-4

25 grams of maltodextrin (13-17 dextrose equivalents) was dissolved in 75 ml of purified water and the mixture was stirred for 10 minutes at room temperature. To this mixture 3.4 gm of Aliquat 336 and 0.175 gm of NaBr were added at room temperature. 30% NaOH solution was added to adjust the pH to 10 to 10.5 and 6.5 gm of tert-butyl hypochlorite (55 to 60 wt. % active chlorine) was added drop wise at 25-30° C. while maintaining the at pH 9.5 to 10.5 by adding 30% NaOH solution simultaneously. The reaction mixture was stirred for 30 minutes at 25-30° C. and at pH 10 and then 40% NaOH solution (4.4ml) was added drop wise to the reaction mass at 25-30° C. To the above reaction mass, iron (III) chloride solution (30.66 gm of FeCl₃ dissolved in 57.5 ml of purified water) was added drop wise over a period of 20 minutes at 25-30° C. and stirred for 15 minutes. Aqueous sodium carbonate solution (24 gm of Na₂CO₃ dissolved in 115 ml of purified water) was added drop wise at 25-30° C. and then 40% NaOH solution was added to establish a pH of 10.5 to 11 and the mixture was heated to 50° C., stirred for 30 minutes. Then the mixture was acidified to pH 5.5 with hydrochloric acid addition and the solution was kept at 50° C. for another 30 minutes. Further temperature was raised to 95-100° C. and stirred for half an hour at pH 5.5. The reaction mixture was allowed to cool to room temperature and filtered through a celite pad. Then the iron (III) complex was isolated by precipitating with ethanol addition drop wise at room temperature. The obtained brown solid was dried under vacuum at 50° C. for 2-3 hours.

Molecular weight=164 kDa

Iron content=25.05% w/w

### EXAMPLE-5

### Step (i)

28 grams of anhydrous iron (III) chloride was dissolved in 50 ml of purified water at room temperature for 10 min stirring. The obtained brownish-yellow clear solution was cooled to 0-5° C. and the pH was adjusted to 7.0 by adding aqueous sodium hydroxide solution (21 gm of NaOH dissolved in 105 ml of purified water). A brown colour precipitate obtained was maintained for 1 hour at 0-5° C. and collected through filtration. The cake was suck dried and used for next step.

### Step (ii)

25 grams of maltodextrin (13-17 dextrose equivalents) was dissolved in 60 ml of purified water and the mixture was stirred for 10 min at room temperature. To this 20% NaOH solution was added to adjust the pH to 10 and followed by 3.4 gm of Aliquat 336 and 0.175 gm of NaBr at room temperature over a period of 15 minutes. 7 gm of tert-butyl hypochlorite was added drop wise at 25-30° C. and maintained reaction mixture at pH 10 by adding 20% NaOH solution simultaneously. The reaction mixture was stirred for 1 hour at 25-30° C. and at pH 10.

At 25-30° C., wet cake of step (i) was added and stirred for 10 minutes. 20% NaOH solution was added drop wise to adjust the reaction mass pH to10-11 and the slurry was heated to 50° C., stirred for 30 minutes (added 20% NaOH solution to maintain the alkaline pH). Then the solution was acidified to pH 5.5 with hydrochloric acid addition and the solution was kept at 50° C. for another 30 minutes. Further temperature was raised to 95-100° C. and stirred for half an hour at pH 5.5. The reaction mixture was allowed to cool to room temperature, adjusted pH to 6.0 with 20% NaOH solution and filtered through a celite pad. Then the iron (III) complex was isolated by precipitating with ethanol addition drop wise at room temperature. The obtained brown solid was dried under vacuum at 50° C. for 2-3 hours.

Molecular weight=177 kDa

Iron content=25.4% w/w

### EXAMPLE-6

### Step (i)

28 grams of anhydrous iron (III) chloride was dissolved in 50 ml of purified water at room temperature for 10 minutes stirring. To this 2 gm of maltodextrin (13-17 dextrose equivalents) was added and stirred for 10 minutes at room temperature. The obtained brownish-yellow clear solution was cooled to 0-5° C. and the pH of the reaction mixture was adjusted to 7.0 by adding 20% aqueous sodium hydroxide solution. A brown colour precipitate obtained was maintained for 1 hour at 0-5° C. and collected through filtration. The cake was suck dried and used for next step.

### Step (ii)

25 grams of maltodextrin (13-17 dextrose equivalents) was dissolved in 60 ml of purified water and the mixture was stirred for 10 minutes at room temperature. To this 20% NaOH solution was added to adjust the pH to 10 and followed by 0.2 gm of NaBr at room temperature. 6 gm of tert-butyl hypochlorite was added drop wise at 25-30° C. and maintained reaction mixture at pH 10 by adding 20% NaOH solution simultaneously. The reaction mixture was stirred for 1 hour at 25-30° C. and at pH 10.

At 25-30° C., wet cake of step (i) was added and stirred for 10 minutes. 20% NaOH solution was added drop wise to adjust the reaction mass pH to10 to 11 and the slurry was heated to 50° C., stirred for 30 minutes (added 20% NaOH solution to maintain the alkaline pH). Then the solution was acidified to pH 5.5 with hydrochloric acid addition and the solution was kept at 50° C. for another 30 minutes. Further temperature was raised to 95-100° C. and stirred for half an hour at pH 5.5. The reaction mixture was allowed to cool to room temperature, adjusted pH to 6.0 with 20% NaOH solution and filtered through a celite pad. Then the iron (III) complex was isolated by precipitating with ethanol addition drop wise at room temperature. The obtained brown amorphous solid was dried under vacuum at 50° C. for 2-3 hours.

Molecular weight=145 kDa

Iron content=21.66% w/w

### Example-7

9.0 Kg of maltodextrin (13-17 dextrose equivalents) was dissolved in 27.0 L of purified water and the mixture was stirred for 10 minutes at room temperature. To this mixture 1.26 Kg of Aliquat 336 and 18.0 g of Na₂WO₄.2H₂O were added at room temperature. 30% NaOH solution was added to adjust the pH to 10 to 10.5 and 2.34 Kg of tert-butyl hypochlorite (55 to 60 wt. % active chlorine) was added drop wise at 25-30° C. while maintaining the at pH 9.5 to 10.5 by adding 30% NaOH solution simultaneously. The reaction mixture was stirred for 15 min at 25-30° C. and at pH 10 and then 40% NaOH solution (0.584 L) was added drop wise to the reaction mass at 25-30° C.

To the above reaction mass, iron (III) chloride solution (11.03 Kg of FeCl₃ dissolved in 20.52 L of purified water) was added slowly drop wise at 25-30° C. Aqueous sodium carbonate solution (8.64 Kg of Na₂CO₃ dissolved in 41.40 L of purified water) was added drop wise at 25-30° C. and then 40% NaOH solution was added to establish a pH of 10.5 to 11 and the mixture was heated to 50° C., stirred for 30 minutes. The reaction mixture was then cooled to 25-30° C. and acidified to pH 5.5 with hydrochloric acid addition and the solution was stirred for another 30 minutes at the same temperature i.e, 25-30° C. Filtered the reaction mixture through hyflo bed and washed the cake with purified water (9.0L×3). Then the iron (III) complex was isolated by precipitating with ethanol (194.3 L) addition drop wise at room temperature and stirred for another 2 hours at the same temperature. Filtered the obtained solid at room temperature under nitrogen atmosphere and washed the cake with ethanol (22.5L×5).

Dried the material under vacuum at 50° C. until constant weight is obtained. Wet Wt.=23-25 Kg; Dry Wt.=14-15 Kg.

1. A process for the preparation of water soluble iron (III) carboxymaltose complex having average molecular weight of 80 kDa to 400 kDa comprising the reaction product of
a) an aqueous solution of Iron (III) salt and
b) an aqueous solution of oxidation product of
i) at least one maltodextrin,
ii) an organic hypohalite as oxidising agent
iii) in the presence of a catalyst and phase transfer catalyst, and
iv) in alkaline medium
wherein, the reaction mixture is stirred for about 15 minutes after the addition of organic hypohalite in alkaline medium,
wherein, the reaction mixture is cooled to 25-30° C. after the addition of Iron (III) salt,
wherein, the reaction mixture in step b) is isolated at a pH of 2 or less at a temperature of 25-30° C. and filtered the reaction mixture,
wherein, the reaction mixture is stirred for about 2 hours at room temperature after the addition of alcoholic solvent.

2. The process according to claim 1, wherein the organic hypohalite is selected from alkyl or aryl or arylalkyl hypohalites, specifically C1-C4 alkyl hypohalites.

3. The process according to claim 1, wherein C1-C4 alkyl hypohalites is t-butyl hypochlorite.

4. The process according to claim 1, wherein the oxidation is carried out at a pH of 9 to 12, at temperatures in the range of 0 to 50° C.

5. An improved process for the preparation of Ferric carboxymaltose (FCM) which comprises:
a) oxidizing at least one maltodextrin in an aqueous solution at a pH in the range of 9 to 12 and a temperature in the range of 0 to 50° C., with tert-butyl hypochlorite in the presence of a catalyst and a phase transfer catalyst to form an oxidized maltodextrin solution,
b) contacting the oxidized maltodextrin solution with an aqueous solution of an iron (III) salt,
c) raising the pH of the oxidized maltodextrin solution and iron (III) salt solution to a value in the range of 9 to 12,
d) raising the temperature of the reaction mixture to a temperature of 50-60°,
e) lowering the temperature of the reaction mixture to a temperature of 25-30° C.,
f) lowering the pH of the oxidized maltodextrin solution and iron (III) salt mixture to a value in the range of 4 to 6,
g) adding alcohol to the aqueous complex and stirring for about 2 hours and
h) isolating Ferric carboxymaltose (FCM) from the solution.

6. The process according to claim 1, wherein the phase transfer catalyst used is selected from C1-C10 alkyl or aryl or arylalkyl ammonium halides, specifically Aliquat 336.

7. The process according to claims 1, wherein the catalyst is transition metal catalyst or an alkali halide.

8. The process according to claim 7, wherein the transition metal catalyst is sodium tungstate.

9. The process according to claim 7, wherein the alkali halide catalyst is alkali bromide, specifically sodium bromide.

10. (canceled)

11. The process according to claim 5, wherein the phase transfer catalyst used is selected from C₁-C₁₀ alkyl or aryl or arylalkyl ammonium halides, specifically Aliquat 336.

12. The process according to claim 5, wherein the catalyst is transition metal catalyst or an alkali halide.
